(19) United States
(12) Patent Application Publication
(10) Pub. No.: US 2018/0341394 A1
(43) Pub. Date: Nov. 29, 2018

(54) Network Visualization Using Circular Heat Maps

(71) Applicant: Brocade Communications Systems, Inc., San Jose, CA (US)

(72) Inventors: Aruna Sangli, San Jose, CA (US); Santhoshkumar Kolathur, Milpitas, CA (US)

(21) Appl. No.: 15/605,640

(22) Filed: May 25, 2017

(51) Int. Cl. G06F 3/0484; H04L 12/24; H04L 12/26; G06T 11/20

(52) U.S. Cl. CPC G06F 3/04847; H04L 41/22; H04L 67/1097; G06T 11/206; H04L 43/045

(57) ABSTRACT

A management station according to the present disclosure displays a circular heat map as a graphic user interface (GUI) element to monitor network element data. The management station determines a point of time along a circular outer ring of the circular heat map, where the circular outer ring represents a timeline. The management station displays network element data at the point of time on the circular heat map such that the circular heat map is divided into a plurality of concentric rings and wedge-like segments. Each of the concentric rings represents a different network scope within a network and each of the wedge-like segments represents a different portion of the network.

### BACKGROUND OF THE DISCLOSURE

### 1. Field of the Disclosure

The present disclosure relates generally to network device management and more particularly to displaying a graphical user interface (GUI) element to visualize network information relating to the performance of a network.

### 2. Description of the Related Art

Network management software provides network administrators a way of tracking, among other things, the bandwidth and memory utilization of ports on a network. For relatively smaller networks with a fewer number of ports and/or other network elements, closely monitoring port utilization in a GUI is a less arduous task. However, for relatively large networks, there are often so many network elements (e.g., ports) that the arrangement, organization, and display of data values for each network element are important to effectively monitor the large networks. For instance, a relatively large network may have thousands of network elements that form complex and inter-related environments. Performing root-cause analysis to isolate network problems and performance degradation for these relatively large and complex networks are typically difficult exercises for network administrators. To perform root-case analysis, network administrators often have to drill down into many dialogs and screens that display large volumes of data in a complex manner.

Displaying network information generally involves having a network management software visualize network data values using a dashboard and/or widget. Network administrators configure the dashboards and/or widgets to track specific network characteristics for certain network elements within a single application window. For example, the single application window can organize and display network data in a tabular format as summarized widgets or as a relatively large table. While widgets and/or dashboards are able to display network data to the network administrators, the quantity and variety of information that widgets and/or dashboards expose can be overwhelming to network administrators. Consequently, even when using widgets and/or dashboards, network administrators may have a difficult time in determining the root cause for network problems and/or performance degradation within a network. As such, improving technology that effectively displays and visualizes data for a network administrator to monitor relatively large networks remains valuable in properly managing network performance.

### SUMMARY OF THE DISCLOSURE

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the invention or to delineate the scope of the invention. Its sole purpose is to present some concepts in a simplified form as a prelude to the more detailed description that is discussed later.

According to the embodiments of the present disclosure, a management station that provides a GUI element, such as a widget or network navigational control interface, that visualizes network element data as a heat map with a circular layout. The circular heat map is able to visualize complex and a relatively large number of data for hierarchical network elements. To visualize hierarchical network element data, the circular heat map includes a timeline represented as a circular outer ring, concentric rings within the widget, where each concentric ring represents a different network scope, and wedge-like segments, where each wedge-like segment includes network element data from a hierarchical network scope tree and/or sub-tree of the network. Non-limiting examples of network characteristics that the network element data pertain to include status information of the network element, traffic utilization of the network element, the network element's link information, network element's capacity (e.g., the amount of ports occupied).

### BRIEF DESCRIPTION OF THE FIGURES

The present disclosure has other advantages and features which will be more readily apparent from the following detailed description of the disclosure and the appended claims, when taken in conjunction with the accompanying drawings, in which:

FIG. 1 is a diagram illustrating a local area network (LAN) and wide area network (WAN) where embodiments of the present disclosure may operate herewith.

FIG. 2 is a schematic diagram of an embodiment of a switching device that may be utilized in an Ethernet network.

FIG. 3 is a schematic diagram of an embodiment of a storage area network (SAN) 300 where embodiments of the present disclosure may operate herewith.

FIG. 4 is a schematic diagram of an embodiment of a switching device that may be utilized in a SAN.

FIG. 5 illustrates a block diagram of a management station that may be utilized in accordance with embodiments of the present disclosure.

FIG. 6 illustrates a circular heat map as a GUI element for representing network element data.

FIG. 7 illustrates another embodiment of a circular heat map for representing network element data.

FIG. 8 illustrates an example utilization of the circular heat map for a relatively small network.

FIG. 9 illustrates an example utilization of the circular heat map for a relatively large network.

FIG. 10 is a flow chart of an embodiment of method used to visualize network information using a circular heat map as GUI element.

### DETAILED DESCRIPTION OF THE PREFERRED EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques described below, including the exemplary designs and implementations illustrated and described herein, but may be modified within the scope of the appended claims along with their full scope of equivalents.

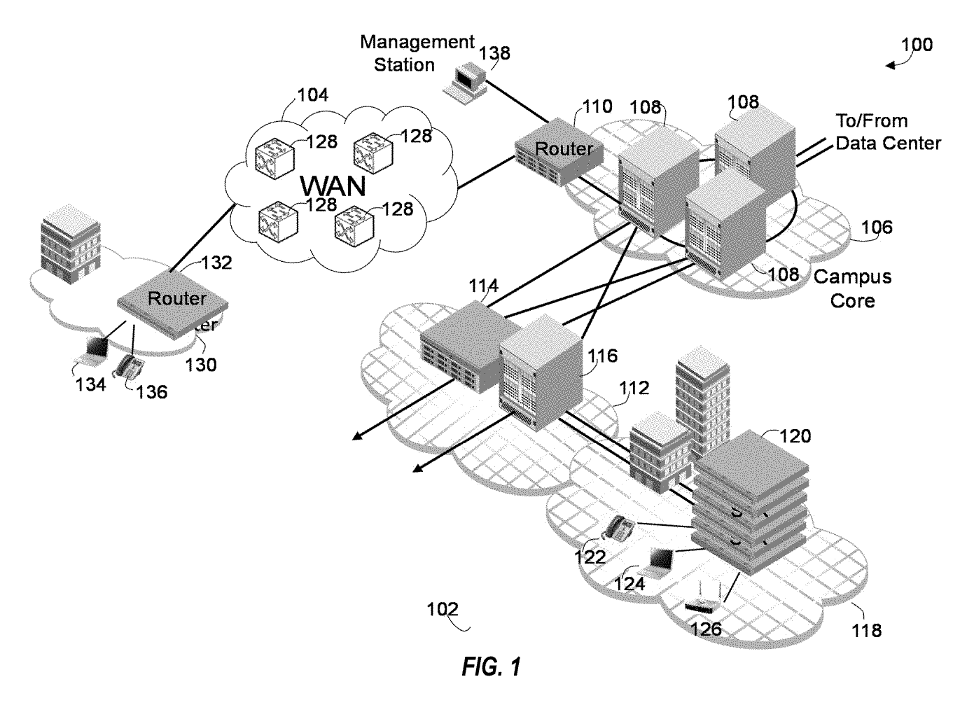

FIG. 1 is a schematic diagram of an embodiment of an Ethernet network 100 where embodiments of the present disclosure may operate herewith. Referring to FIG. 1, an Ethernet network 100 is shown where a LAN 102 is interconnected to a remote campus 130 via WAN 104. The campus core 106 includes a plurality of interconnected core switches 108. The core switches 108 are connected to a data center (not shown). A router 110 is connected to the core switches and the WAN 104. The LAN 102 is connected to the WAN 104 via router 110. The core switches 108 are connected to switches 114 and 116 of an aggregation campus 112. The aggregation campus switches 114 and 116 are connected to switches 120 of large network 118 and provide data communication services to the large network's telephone 122, computer 124, and wireless access 126 devices. The aggregation network switches 114 and 116 may also be connected to additional campuses (not shown) in order to provide additional data communication services. The WAN 104 is comprised of a plurality of interconnected Ethernet switches 128 and other networking elements (not shown). WAN 104 is connected to remote campus 130 via a router 132. Router 132 provides data communication services to computers 134 and telephone devices 136. It is understood that this is an exemplary network and numerous other network topologies can be monitored according to the present invention.

As shown in FIG. 1, a management station 138 is connected to router no of the campus core 106. As will be appreciated by one having ordinary skill in the art, the management station 138 allows a network administrator to monitor the data traffic, port utilization, traffic flows, and/or various other networking characteristics of each network element (e.g., switches 114 and 116) in the Ethernet network too. Stated another way, the management station 138 is configured to deliver visibility and insight access to Ethernet network 100, such as detecting network anomalies. Unless otherwise specified within the disclosure, the term “management station” may be interchanged with and considered synonymous throughout this disclosure with the term “network advisor.” Moreover, unless otherwise specified within the disclosure, the term “network characteristic” may be interchanged with and considered synonymous throughout this disclosure with the terms “network metric” and “network parameter.”

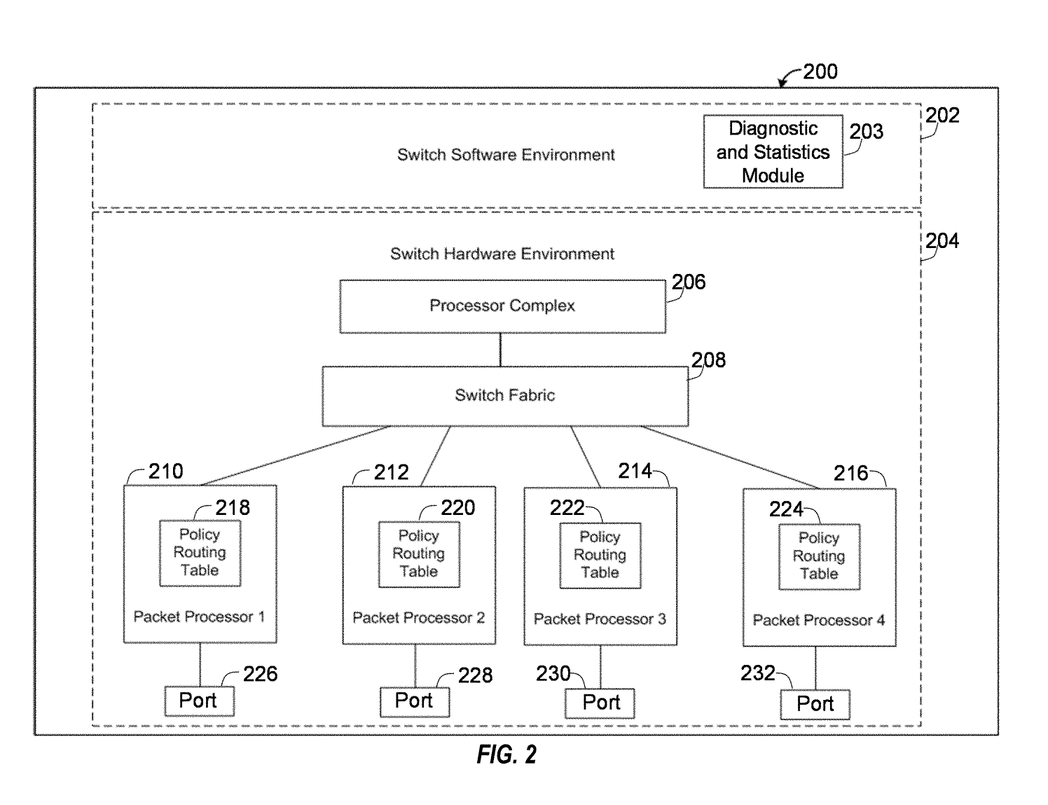

FIG. 2 is a schematic diagram of an embodiment of a switching device 200 (e.g., an Ethernet switch) that may be utilized in an Ethernet network, such as Ethernet network 100 shown in FIG. 1. The switching device 200 comprises a switch software environment 202 and switch hardware environment 204. The switch software environment 202 includes a diagnostics and statistics module 203 to allow the network management software access to the various statistical counters in the switching device 200, such as receive and transmit rate counters for each port 226, 228, 230, 232. In one embodiment, the diagnostics and statistic module 203 includes a monitoring and alerting policy suite (MAPS) module that stores and implements rules and/or policies related to monitoring network characteristics, such as data traffic and/or traffic flows. The MAPS module monitors the network characteristics at the switching device 200 and compares the switching device 200 to one or more thresholds. Based on the comparison, the MAPS module may generate and transmit a notification of possible performance issues back to a management station to alert a network administrator. In preferred embodiments, the MAPS module includes elements of the switch fabrics 208 and/or processor complex 206 to perform frame counting and software elements to program the counters and to read the counters and to perform data manipulation.

FIG. 2 illustrates that the switch hardware environment 204 has a processor complex 206 that provides the overall management and control of the switching device 200. The processor complex 206 is connected to a switch fabric 208, which provides the basic switching operations for the switching device 200. The switch fabric 208 is connected to a plurality of packet processors 210, 212, 214, and 216. Each packet processor 210, 212, 214, and 216 has its own respective policy routing table 218, 220, 222, and 224 to provide conventional packet analysis and routing. Each packet processor 210, 212, 214, and 216 is connected to its own respective port or ports 226, 228, 230, and 232. When the switching device 200 is implemented in a network, such as Ethernet network 100, the data value of each port 226, 228, 230, and 232 may be monitored and analyzed using a network management software on a management station, such as management station 138 shown in FIG. 1. Again, it is understood that this is an exemplary switching device architecture and numerous other architectures can be used according to the present invention.

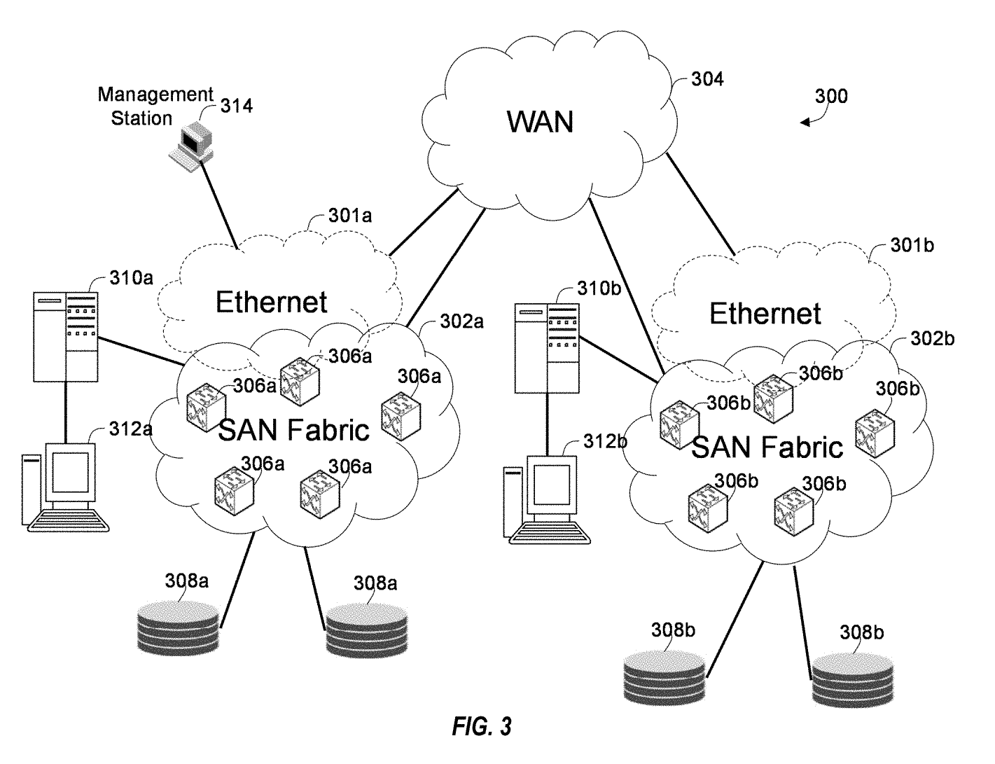

FIG. 3 is a schematic diagram of an embodiment of a SAN 300 where embodiments of the present disclosure may operate herewith. The SAN 300 may utilize the Fibre Channel (FC) protocol to transmit and receive data. As shown, a plurality of FC SAN fabrics 302a and 302b are interconnected via WAN 304. The SAN fabrics 302a and 302b are comprised of a plurality of FC switches 3o6a and 3o6b, respectively. SAN fabric 302a is connected to a plurality of storage devices 308a. Likewise, SAN fabric 302b is connected to a plurality of storage devices 308b. Each SAN fabric 302a and 302b connect their respective storage devices 308a and 308b to application servers 310a and 310b, which are in turn are connected to computers 312a and 312b. This configuration allows for computer 312a to access storage devices 308b and for computer 312b to access storage devices 308a. As above, FIG. 3 is an exemplary FC SAN architecture and numerous other FC architectures can be managed according to the present invention.

As shown in FIG. 3, a management station 314 is connected to Ethernet LAN 301a, which is connected directly to SAN network 302a and indirectly to Ethernet LAN 301b via WAN 304. Ethernet LANs 301a and 301b are connected to the Ethernet management ports of the switches 306a and 306b to provide a management network for the switches 306a and 306b. As will be appreciated by one having ordinary skill in the art, the management station 314 allows a network administrator to monitor the data traffic, port utilization, traffic flow, and/or other networking characteristics for network elements using network management software. The management station 314 may be configured to perform similar operations as described for management station 138 shown in FIG. 1.

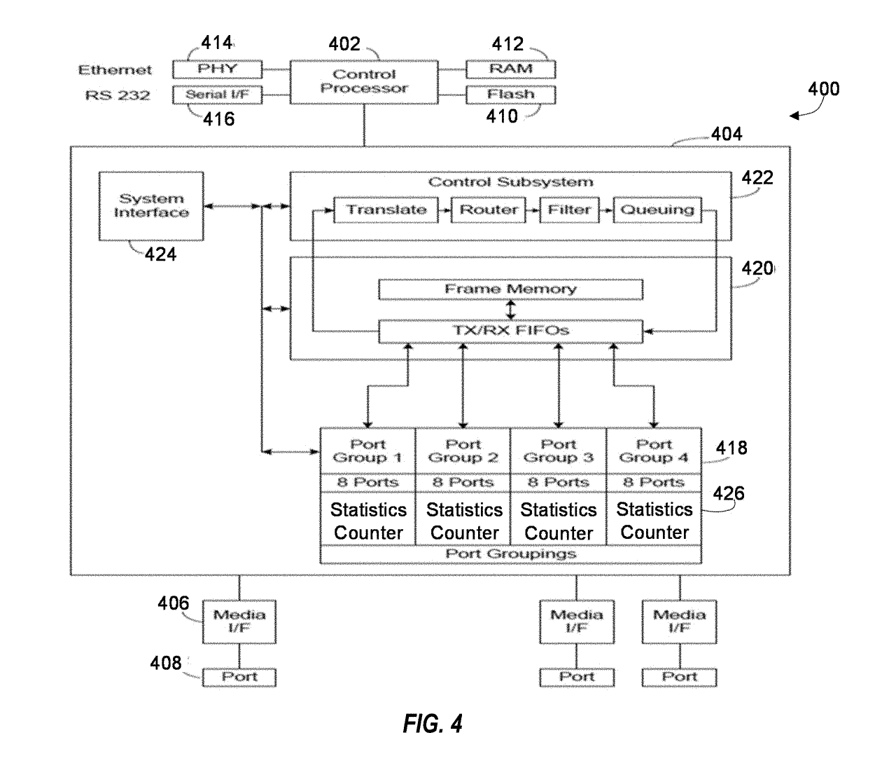

FIG. 4 is a schematic diagram of an embodiment of a switching device 400 (e.g., a FC switch) that may be utilized in a SAN, such as SAN 300 shown in FIG. 3. FIG. 4 illustrates that a control processor 402 is connected to a switch ASIC 404. The switch ASIC 404 is connected to media interfaces 406 which are connected to ports 408. Generally, the control processor 402 configures the switch ASIC 404 and handles higher level switch operations, such as the name server, the redirection requests, and the like. The switch ASIC 404 handles the general high speed inline or in-band operations, such as switching, routing, and frame translation. The control processor 402 is connected to flash memory 410 to hold the software, to RAM 412 for working memory and to an Ethernet PHY 414 used for management connection and serial interface 416 for out-of-band management.

The switch ASIC 402 has four basic modules, port groups 418, a frame data storage system 420, a control subsystem 422 and a system interface 424. Generally, frames are received from a media interface 406 and provided to the frame data storage system 420. Further, frames are received from the frame data storage system 420 and provided to the media interface 406 for transmission out a port 408. The port groups 418 perform the lowest level of packet transmission and reception, and include a statistics counter module 426 to allow diagnostic and statistics software to access the various statistical counters of the switching device 400, such as receive and transmit rate counters for each port.

In one embodiment, the diagnostic and statistics software includes a MAPS module that is similar to the MAPS module included in FIG. 2's diagnostics and statistic module 203. Recall that the MAPS module stores and implements rules and/or policies related to monitoring network characteristics, such as data traffic and/or traffic flows. The MAPS module may use the statistics counter module 416 to obtain data regarding network characteristics and compare this data to one or more thresholds. In preferred embodiments, the MAPS module includes elements of the switch ASIC 404 to do frame counting and software elements to program the counters and to read the counters and to perform data manipulation.

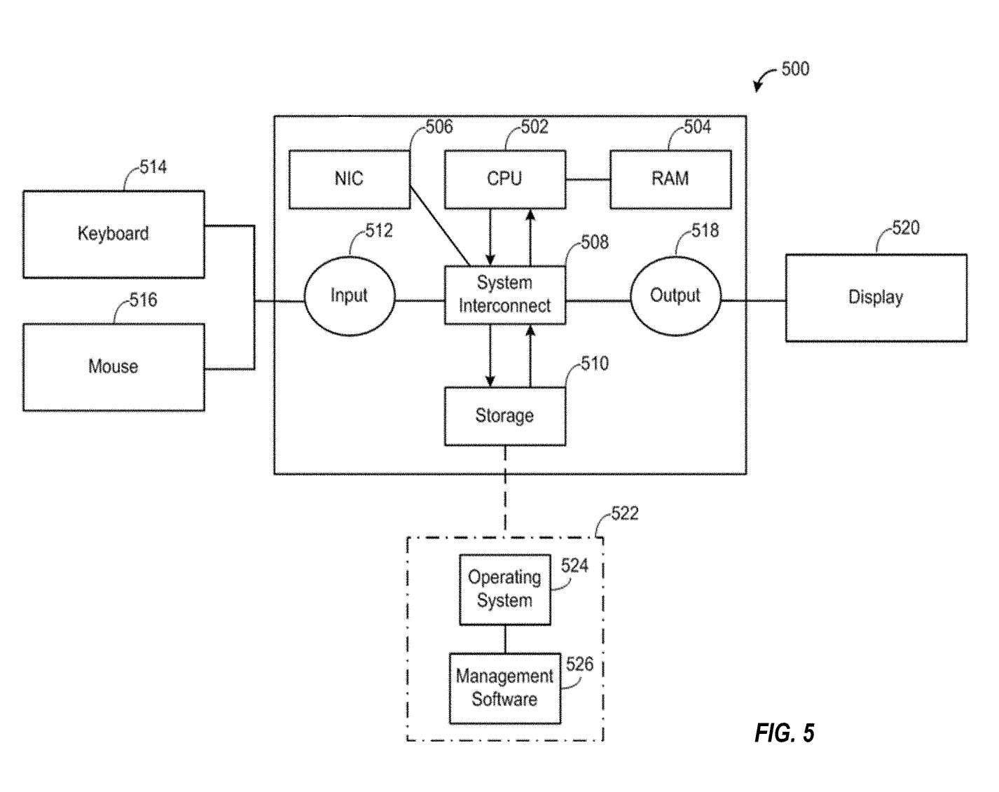

FIG. 5 illustrates a block diagram of a management station 500, similar to management stations 138 and 314, utilized in accordance with embodiments of the present disclosure. As shown, the management station 500 comprises a central processing unit (CPU) 502, random access memory (RAM) 504, network interface card (NIC) 506, system interconnect 508, storage component 510, input component 512, and output component 518 which are all interconnected via the system interconnect 508. The input component 512 may be connected to an input device, such as a keyboard 514 and mouse 516. The output component 518 is connected to a display device 520, such as an LCD monitor. Storage component 510, such as a non-transitory storage device, stores software 522, which typically includes an operating system 524 and network management software 526. The NIC 506 allows the management station 500 to communicate with a network. It is understood that this is an exemplary computer system architecture and numerous other computer architectures can be used according to the present invention.

As understood by those skilled in the art, network management software 526 is typically designed to allow a network administrator to quickly and efficiently monitor and manage a relatively large network via a GUI, such as an analytic dashboard. The network management software 526 could be, for example, Brocade® Network Advisor, which is made by Brocade Communication Systems, Inc. Once booted, the management station 500 loads the operating system 524 from the storage 510 into the RAM 504. From the operating system 524 a user may run the network management software 526, which is then also loaded into the RAM 504. The interface of the network management software 526 is then displayed on the display 520 via the output component 518. The management software 526 allows a user to monitor numerous network characteristics, such as the number events on the network, number of unused ports of network devices, memory utilization of network devices, bandwidth utilization of network devices, and CPU utilization of network devices.

In one embodiment, the management station 500 in combination with the network management software 526 are configured to display network element data within a circular heat map. The circular heat map is a GUI element, such as a widget and/or network navigational control interface that visualizes data for a network administrator to view. Instead of displaying network element data within a tabular-based user interface and/or table, data for network elements are visualized within wedge-like segments of the circular heat map. Each wedge-like segment of the circular heat map represents different portions of a network. For example, each wedge-like segment of the circular heat map represents a different network hierarchical tree and/or sub-tree of network element. The network element data located within each wedge-like segment of the circular heat map correspond to network elements (e.g., ports and switches) located within each corresponding portion of the network. The network element data represents one or more network characteristics, such as, status information, traffic utilization, link information, and/or capacity information for the network elements.

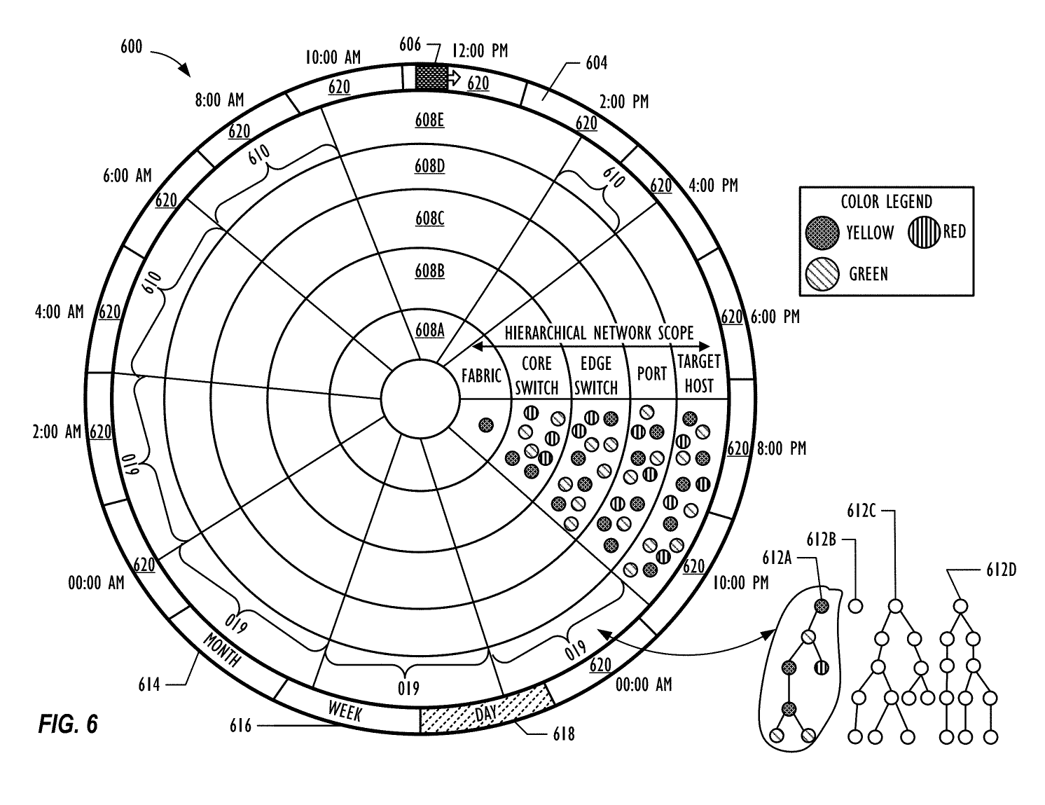

The circular heat map also includes an outer-most circular ring and one or more inner concentric rings. The outer-most circular ring controls the time frame for the displayed network element data. Stated another way, a network administrator is able to view network element data at different time frames with the outer-most circular ring. In one embodiment, the outer-most circular ring represents a timeline for a specific time frame. Within the circular heat map are one or more inner concentric rings, where each inner concentric ring represents a different network scope. The term network scope, as used herein in this disclosure, refers to a specific area of a network or a subset of network elements within an area of the network (e.g., fabric, devices, or groups). Non-limiting examples of network scopes include the entire network, any SAN fabric of the network, any Ethernet fabric of the network, any system-defined group of the network, any user-defined group of the network (e.g., port group), and/or any user-defined customized network. The circular heat map to visualize network element data is shown in more detail in FIGS. 6-9.

Although FIGS. 1-5 illustrate specific embodiments of a network, switching device, and management stations, the disclosure is not limited to the specific embodiments illustrated in FIGS. 1-5. For example, FIGS. 1 and 3 illustrate that embodiments of the present disclosure may operation on Ethernet network 100 and SAN 300; however, other embodiments may operate in other types of networks, such as radio-based networks (e.g., wireless fidelity (Wi-Fi®), Bluetooth®, and Zigbee® networks) and network on chips (NoC). Further, while FIGS. 1-5 illustrate that the switching devices (e.g., switching devices 200 and 400) and management station (e.g., management station 500) as separate and independent devices, other embodiments could have one or more of the switching devices and/or the management station as subsystems or components located on a single device, such as an integrated circuit. The use and discussion of FIGS. 1-5 are only examples to facilitate ease of description and explanation.

FIG. 6 illustrates a circular heat map 600 as a GUI element for representing network element data. For example, the circular heat map 600 could be a heat map widget in a dashboard and/or a network navigational control interface. In particular, FIG. 6 illustrates that circular outer ring 604 has been configured to represent a time frame of a day or 24 hour period by selecting and/or activating the day time frame indicator 618. A network administrator is able to adjust the time interval for the circular outer ring 604 by selecting and/or activating the time frame indicators 614, 616, and 618. Using FIG. 6 as an example, to change the time frame for the circular outer ring 604 from a day to a month time frame, a network administrator may select or activate the month time frame indicator 614. Alternatively, the network administrator may select or activate the week time frame indicator 616 to adjust the time frame for the circular outer ring 604 from a day to a week time frame. Although FIG. 6 illustrates that the time frame indicators 614, 616, and 618 are part of the circular outer ring 604, other embodiments of the circular heat map 600 could have the time frame indicators 614, 616, and 618 located outside of the outer ring 604, for example, on a different ring or as a separate widget in close proximity to the circular heat map 600.

FIG. 6 also illustrates that circular heat map 600 can provide time interval indicators 620 that subdivide the circular outer ring 604 into smaller time intervals. By having the circular outer ring 604 represent a timeline, a network administrator is able to view network information in a historical context. The smaller time intervals for the time interval indicators 620 will vary depending on which time frame indicator 614, 616, and 618 a user selects. In FIG. 6, based on selecting and/or activating the day time frame indicator 618, the time interval indicators 620 subdivides the circular outer ring 604 into two hour intervals for the 24 hour period. Other embodiments could have differing number of time interval indicators 620 and time intervals for the time interval indicators 620 when selecting and/or activating the day time frame indicator 618. For example, embodiments where the time frame indicators 614, 616, and 618 are located outside of the outer ring 604, there could be 24 time interval indicators 620 along the outer ring 604 that represent one hour time intervals. Selection of the time frame indicators 614 and 616 generates time intervals and/or the number of time interval indicators 620 that differ than the two hour time intervals shown in FIG. 6. As an example, when a user activates or selects the time frame indicator 614, the number of time interval indicators 620 could increase from 12 to 30, where each time interval indicator 620 represents a 24 hour or a day time period.

Overlaid on top of the circular outer ring 604 is a moveable time frame indicator 606 that allows a network administrator to view network element data at a specific point in time. As described above, in one embodiment, the circular outer ring 604 represents a timeline within a specific time frame (e.g., 24 hour time frame when day time frame indicator 618 is set). A network administrator is able to relocate the moveable time frame indicator 606 to different positions along the circular outer ring 604 to view network element at different times. When a network administrator advances the moveable time frame indicator 606 (e.g., clicking and dragging) along the circular outer ring 604, the circular heat map 600 displays network element data corresponding to the time frame the moveable time frame indicator 606 overlays over and/or points to on the circular outer ring 604. Using FIG. 6 as an example, the movable time frame indicator 606 overlays over the 12:00 PM portion of the circular outer ring 604. Based on the positioning of the movable time frame indicator 606, the circular heat map 600 displays the network element data collected at 12:00 PM for each of the wedge-like segments 608.

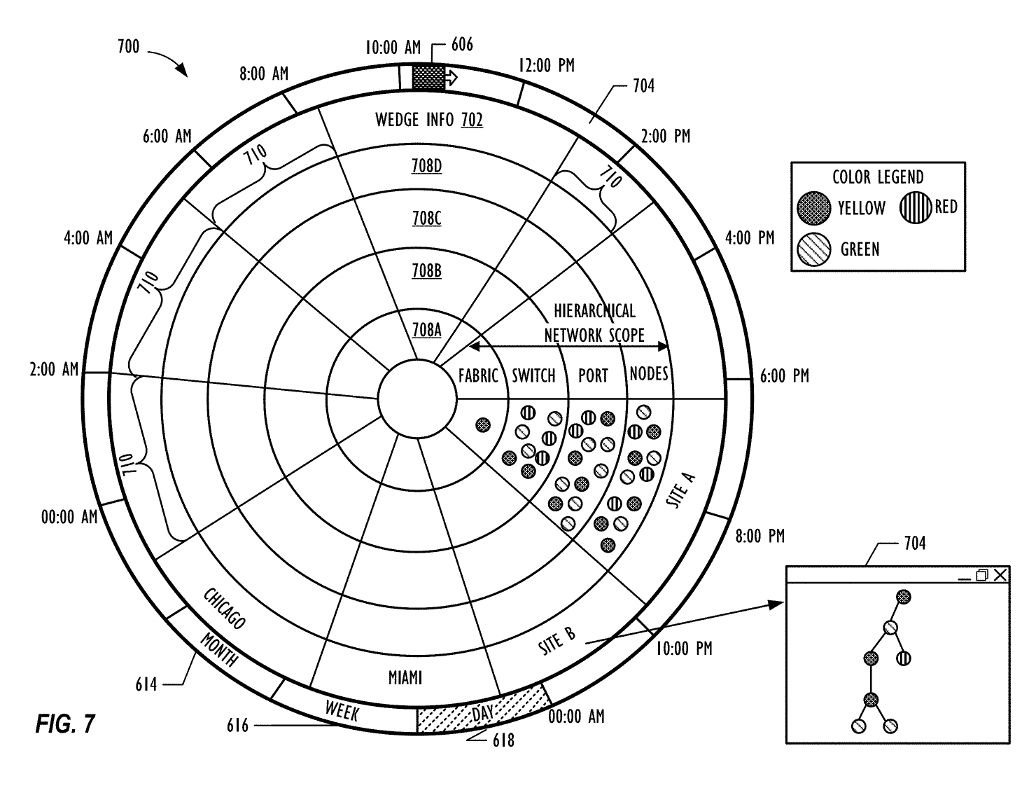

As shown in FIG. 6, the circular outer ring 604 represents a timeline with a plurality of specific or discrete time frames. Stated another way, the time interval indicators 620 represent specific or discrete times a network administrator may view with the circular heat map 600. For example, FIG. 6 illustrates that the circular outer ring 604 is divided into two hour segments. If a network administrator decides to view network element data at 12:00 PM, the network administrator moves the time frame indicator 606 and/or clicks along the timeline segment corresponding to the 12:00 PM time interval indicator 620. To obtain network element data for 2:00 PM, the network administrator may move the time frame indicator 606 and/or click along the timeline segment that corresponds to the 2:00 PM time interval indicator 620. In this embodiment, the circular outer ring 604 is unable to display network element data from other discrete times (e.g., 1:00 PM time). In another embodiment, the circular heat map 600 includes finer granularity subdivisions within the time interval indicator 620 that are not explicitly shown using a specific indicator. When a user move the movable time frame indicator 606 in between two different time interval indicators 620, the movable time frame indicator 606 can point to a particular time interval subdivision of the circular outer ring 560. The particular time interval subdivision of the circular outer ring 560 could represent a time interval smaller than the time interval indicators 620, such as five minute and/or fifteen minute time intervals. The time intervals for the time interval subdivision can be based on a predetermined data sampling interval. Implementing a more continuous timeline for the circular outer ring 604 is described in more detail in FIG. 7.

The circular heat map 600 includes one or more concentric rings 608, where each concentric ring 608 represents different network scopes. Specifically, FIG. 6 depicts that the circular heat map 600 includes a plurality of concentric rings 608A-608E that correspond to the following hierarchical network scope classifications: concentric ring 608A is representative of a fabric, concentric ring 608B is representative of core switches, concentric ring 608C is representative of edge switches, concentric ring 608D is representative of ports, and concentric ring 608E is representative of targets and hosts. The concentric rings 608 partition the circular heat map 700 such that network element data located within specific regions of the concentric rings 608A-608E represents network information from the corresponding network scope classification. Using FIG. 6 as an example, network element data that falls within concentric ring 608A represents network information for the fabric; network element data that falls between concentric ring 608A and concentric ring 608B (i.e., non-overlapping region of concentric ring 608B) would correspond to network information for individual core switches; network element data that falls between concentric ring 608B and concentric ring 608C (i.e., non-overlapping region of concentric ring 608C) would correspond to network information for individual edge switches, and so forth. Other embodiments of the circular heat map 600 may define concentric rings 608A-608E using other network scope classifications. The network scopes may be defined and set by the network administrator and/or network management software and may correspond to physical and/or logical network elements.

The circular heat map 600 also includes a plurality of wedge-like segments 610, where each wedge-like segment 610 represents a different portion of the network. In one embodiment, each wedge-like segment 610 corresponds to a hierarchical network scope tree, where each hierarchical network scope tree 612 represents a different fabric. As illustrated in FIG. 6, a network can be represented by a plurality of hierarchical network scope trees 612A-612D. Each of the hierarchical network scope trees 612A-612D can correspond to one of the wedge-like segments 610. The network element data within each wedge-like segments 610 can represent different nodes on a hierarchical network scope tree 612. For example, the network element data shown within the concentric ring 608A could represent the root node of the hierarchical network scope tree 612C while network element data located between concentric ring 608D and 608E could represent different leaf nodes within the hierarchal network scope tree 612C. In one embodiment, the number of hierarchical network scope trees 612A-612D (e.g., the number of fabrics) within a network determines the number of wedge-like segments 610 found within the circular heat map 600.

FIG. 6 illustrates that the concentric rings 608 divides the wedge-like segments 610 into different sections, where each section includes network element data. The network element data includes one or more indicators to represent one or more network characteristics found within the particular sections. The network element data indicators and its location within the different concentric rings 608 and wedge-like segment 610 provides a visual problem level summary to a network administrator. In particular, a network element data indicator located in a specific section of the wedge-like segment 610 represents a particular network element located within a portion of the network. For example, the circular heat map 600 is configured to display a network element indicator as a color indicator that represents a network element status. The location of the network element indicator could represent that the network element is a network fabric for a specific location of the network. A green color indicates that the network element's status is normal; a yellow color indicates the network element is experiencing some congestion or performance issues; and a red color indicates a network element failure or overload condition. Other embodiments can have the network element data include indicators that represent other types of network characteristics, such as traffic utilization, link information, and/or network capacity, and/or other types of visual indicators besides using color.

FIG. 7 illustrates another embodiment of a circular heat map 700 for representing network element data. The circular heat map 700 differs from the circular heat map 600 shown in FIG. 6 such that the circular heat map 700 includes a concentric ring 702. The concentric ring 702 represents information for the wedge-like segments 710. In one embodiment, the concentric ring 702 can include text that identifies the location for each of the fabrics. As shown in FIG. 7, the concentric ring 702 includes texts that identify the locations for a network, such as WAN. In particular, FIG. 7 illustrates that the network has fabrics located in a variety of different geographic location, such as Chicago, Miami, and sites A and B. Other embodiments of circular heat map 700 could have other type of information for wedge-like segments 710. FIG. 7 also illustrates that when a network administrator selects one of the wedge-like segments 710, the circular heat map 700 may generate a window 704 that displays the topology of the hierarchical network scope tree to a network administrator.

The circular heat map 700 is also configured to have a different hierarchical network scope classifications for concentric rings 708A-708D than the hierarchical network scope classifications for concentric rings 608A-608E shown in FIG. 6. Specifically, FIG. 7 illustrates that the network scope classification for the concentric rings 708A-708D also differ. FIG. 7 depicts network element data that falls within concentric ring 708A is representative of a fabric; network element data that falls between concentric ring 708A and concentric ring 708B represent switches; network element data that falls between concentric ring 708B and concentric ring 708C represent ports; and network element data that falls between concentric ring 708C and concentric ring 708D represent nodes. FIG. 7 also depicts that the number of concentric rings 708A-708D to represent the hierarchical network scope classifications have been reduced from five concentric rings 608A-608E shown in FIG. 6 to four concentric rings 708A-708D. The number of concentric rings 708A-708D is determined from the number hierarchical network scope classifications set by a network administrator or network management software.

The circular heat map 700 also illustrates that the circular outer ring 704 is a more continuous timeline that include time markers that a network administrator may reference. As shown in FIG. 7, the time markers are spread out to represent two hour intervals. When a network administrator wants to view the circular heat map 600 at a time not represented by the time markers, the network administrator may click, move the time frame indicator 606, and/or provide other user input to indicate a desired point in time on the more continuous timeline. For example, if a network administrator wants to view network element data at about 1:30 PM, the network administrator can place the time frame indicator 606 between the 12:00 PM marker and the 2:00 PM marker. Additionally or alternatively, the network administrator could also click on a point on the more continuous timeline represented by the circular outer ring 704. Afterwards, the circular heat map 700 could display a small prompt for the network administrator to view to indicate the actual point in time (e.g., 1:28 PM) of the displayed network element data within the circular heat map 600.

Although FIGS. 6 and 7 illustrate specific embodiments of a circular heat maps 600 and 700, respectively, the disclosure is not limited to the specific embodiments illustrated in FIGS. 6 and 7. For example, FIGS. 6 and 7 provide examples of hierarchical network scope classifications for each of the concentric rings; however, other embodiments may have the concentric rings represent other hierarchical network scope classifications. Additionally or alternatively, the number of wedge-like segments and concentric rings may vary from the numbers shown in FIGS. 6 and 7 depending on the number of hierarchical network scope trees in a network and the number of hierarchical network scope classifications, respectively. Other embodiments of the circular heat map could also place the timeline as one of the inner concentric rings rather than the circular outer ring. The use and discussion of FIGS. 6 and 7 are only examples to facilitate ease of description and explanation.

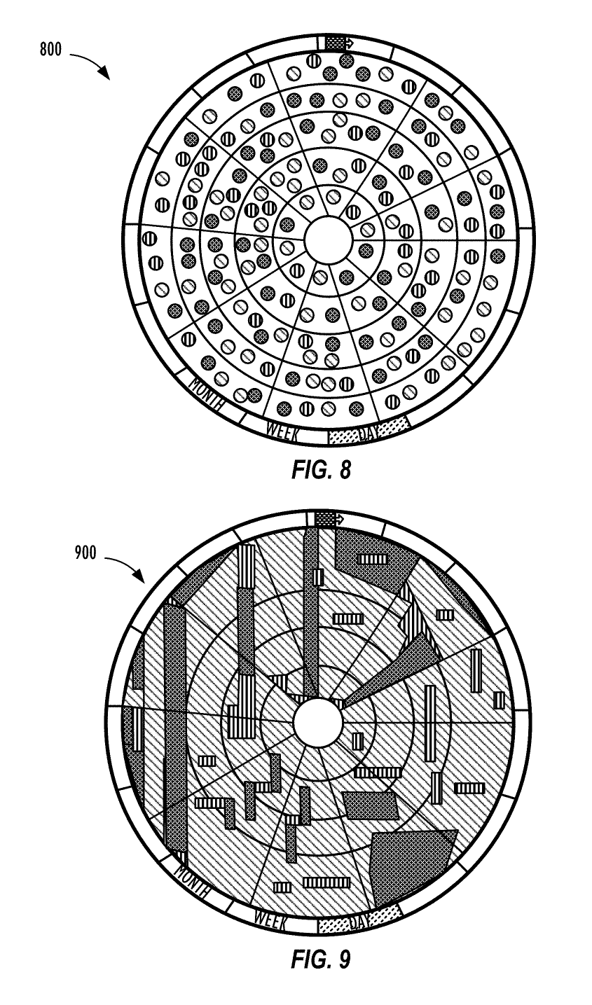

FIGS. 8 and 9 illustrate example utilization of the circular heat map 800 and 900, respectively, as a GUI element. In FIG. 8, the circular heat map 800 provides a visual problem level summary for a relatively small network, and in FIG. 9, the circular heat map 900 provides a visual problem level summary for a relatively large network. The quantity of network element data located within each wedge-like segment of the circular heat map 800 is much less dense than the quantity of network element data located within the circular heat map 900. By viewing the different color indications at the different location of the circular heat maps 800 and 900, a network administrator is able to quickly determine which portions of a network are experiencing performance issues. In particular, the network administrator may utilize the visualized information within the circular heat maps 800 and 900 to drill down and determine the root causes for the network failures and/or performance degradation. For example, selecting network element data indicators (e.g., red colored indicator) could cause a popup of details of the selected indicator. Using FIG. 6 as an example, if a network administrator selects a red network element data indicator in the concentric ring 608B (e.g., core switch ring), then pop up appears to provide more detail information about the particular core switch. In FIG. 9, because the circular heat map 900 has a relatively higher density, the circular heat map 900 does not readably indicate specific locations of problems, selection of given wedge-like segments could produce an enlarged version of the wedge-like segment for a user to differentiate the different network elements.

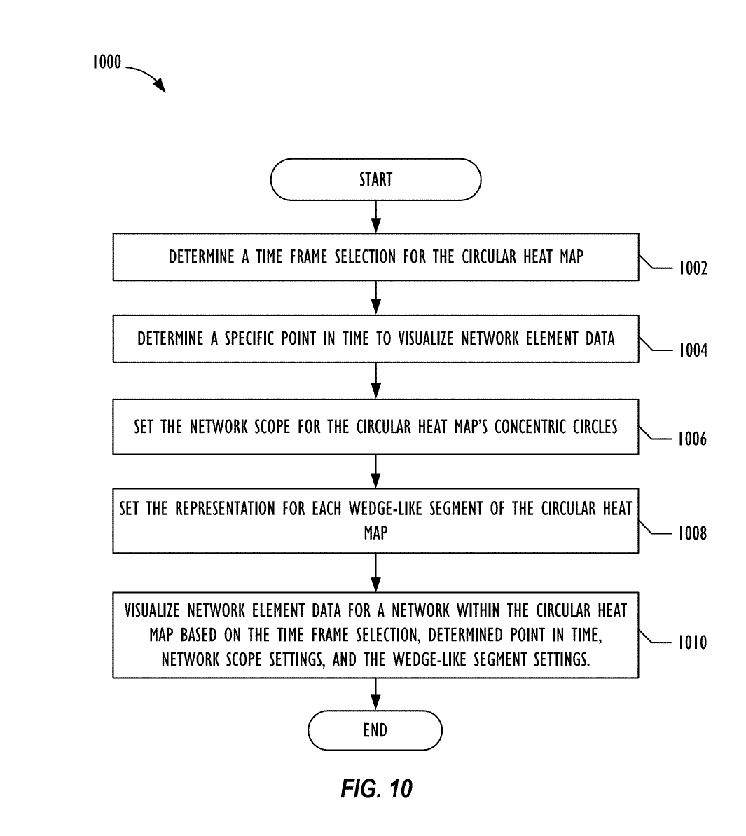

FIG. 10 is a flow chart of an embodiment of method 1000 used to visualize network information using a circular heat map as GUI element. Using FIGS. 1-5 as an example, method 1000 is implemented using the management station as described above (e.g., management station 138, 314, and 500). Method 1000 may operate as part of a dashboard and/or GUI associated with network management software (e.g., network management software 526 shown in FIG. 5). Although FIG. 10 illustrates that the blocks of method 1000 are implemented in a sequential operation, other embodiments of method 1000 can have one or more blocks implemented in parallel operations. Method 1000 starts at block 1002 to determine a time frame selection for the circular heat map. In one embodiment, method 1000 determines a time frame selection by receiving a selection or activating time frame indicators that corresponds to different time intervals that include, but are not limited to a day, a week, and/or a month. The selected and/or activated time frame indicators can be part of the circular heat map.

Method 1000 then moves to block 1004 to determine a specific point in time to visualize network element data. In one embodiment, method 1000 determines the specific point in time based on a circular outer ring and a moveable time fame indicator of the circular heat map. In this instance, the circular outer ring represents a timeline for the determined time frame. The specific point in time to visualize network element date depends on the location of the moveable time frame indicator along the circular outer ring. For example, if method 1000 determines that the time frame is a 24 hour time frame, the circular outer ring represents a timeline for a 24 hour time frame. Relocating the moveable time frame to different locations along the circular outer right would visualize network element data at different times within the 24 hour time frame. The specific point in time can correspond to the time the moveable time frame indicator points to and/or overlays on the circular outer ring.

Method 1000 continues to block 1006 to set the network scope of the circular heat map's concentric rings. In one embodiment, the circular heat map's concentric rings represent different hierarchical network scopes for a network. For example, the first concentric ring represents a fabric within a network, the second next concentric ring represents core switches within the fabric, the following concentric ring after the second concentric ring represents virtual switches within the fabric, and so forth. Other embodiments of method 1000 may set the network scope to correspond to other physical and/or logical network element classifications. To set the network scopes, method 1000 may utilize user inputs from a network administrator and/or parameter settings from the network management software.

Method 1000 continues to block 1008 to set the representation for each wedge-like segment of the circular heat map. In particular, method 1000 sets each wedge-like segment to different portions of the network. In one embodiment, method 1000 sets each wedge-like segment to represent a different fabric of the network, where each fabric can be represented as a hierarchical network scope tree and/or sub-tree. The network element data found within each wedge-like segment can represent different nodes on the network hierarchical network tree. For example, some of the network element data correspond to different leaf nodes on a hierarchal network scope tree. Other embodiments of method 1000 can set the representation for each wedge-like segment to other groups and/or portions of the network. Similar to block 1006, method 1000 at block 1008 can set the representation of each wedge-like segment based on user inputs from a network administrator and/or parameter settings from the network management software.

Method 1000 proceeds to block 1010 to visualize network element data for a network within the circular heat map based on the time frame selection, determined point in time, network scope settings, and the wedge-like segment settings. At block 1010, method 1000 may have the network element data represent a network characteristic. The network element data may include indicators, such as a color indicator, to generate a visual problem level summary to a network administrator. As an example, the network element data includes a color indicator that represents a network element status where a green color indicates that the network element's status is normal; a yellow color indicates the network element is experiencing some congestion or performance issues; and a red color indicates a network element failure or overload condition. Other embodiments of method 1000 can visualize network element data that include indicators that represent other types of network characteristics, such as traffic utilization, link information, and/or network capacity. Additionally or alternatively, other types of indicators may use other visual markers besides color to visualize the network element data.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about to includes, 2, 3, 4, etc.; greater than 0.10 includes 0.11, 0.12, 0.13, etc.). The use of the term “about” means+±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of.

The above description is intended to be illustrative, and not restrictive. For example, the above-described embodiments may be used in combination with each other. Many other embodiments will be apparent to those of skill in the art upon reviewing the above description. The scope of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method comprising:
presenting a circular heat map graphical user interface (GUI) element that comprises:
a circular outer ring that represents a timeline and having markings that indicate portions of the timeline;
a plurality of wedge-like segments, wherein each of the wedge-like segments represents a different portion of a network;
a plurality of concentric rings, wherein each of the concentric rings represents a different network scope within a network, wherein the concentric rings divide each of the wedge-like segments into a plurality of sections, each section comprising the corresponding concentric ring network scope for that portion of the network; and
a plurality of network element indicators in the sections, each network element indicator representing a network element assigned to the particular section; and
displaying, on the presented circular heat map GUI element, the network element indicators appropriate for a point of time for the network, wherein the point of time corresponds to a portion of the circular outer ring, and wherein the network element indicator is a color that represents one or more network characteristics of the corresponding network element.

2. The method of claim 1, wherein the markings represent a plurality of discrete time segments, and wherein one of the discrete time segments corresponds to the point of time.

3. The method of claim 1, wherein each of the different portions of the network corresponds to a different fabric within the network.

4. The method of claim 3, wherein the number of wedge-like segments within the circular heat map GUI element is determined from the number of different fabrics within the network.

5. The method of claim 1, wherein the point of time along a circular outer ring is displayed with a moveable time frame indicator along the circular outer ring.

6. The method of claim 1, further comprising setting a time frame for the circular outer edge.

7. The method of claim 1, wherein the network element indicators within each wedge-like segment corresponds to nodes within a hierarchical network scope tree.

8. The method of claim 1, wherein the number of concentric rings within the circular heat map GUI element is determined from the number of different network scope classifications for the network.

9. A non-transitory program storage device, readable by one or more programmable control devices and comprising instructions stored thereon to cause the one or more programmable control devices to:
present a circular heat map graphical user interface (GUI) element that comprises:
a circular outer ring that represents a timeline and having markings that indicate portions of the timeline;
a plurality of wedge-like segments, wherein each of the wedge-like segments represents a different portion of a network;
a plurality of concentric rings, wherein each of the concentric rings represents a different network scope within a network, wherein the concentric rings divide each of the wedge-like segments into a plurality of sections, each section comprising the corresponding concentric ring network scope for that portion of the network; and
a plurality of network element indicators in the sections, each network element indicator representing a network element assigned to the particular section; and
display, on the presented circular heat map GUI element, the network element indicators appropriate for a point of time for the network, wherein the point of time corresponds to a portion of the circular outer ring, and wherein the network element indicator is a color that represents one or more network characteristics of the corresponding network element.

10. The non-transitory program storage device of claim 9, wherein the markings represent a plurality of discrete time segments, and wherein one of the discrete time segments corresponds to the point of time.

11. The non-transitory program storage device of claim 9, wherein each of the different portion of the network corresponds to a different fabric within the network.

12. The non-transitory program storage device of claim 1, wherein the number of wedge-like segments within the circular heat map GUI element is determined from the number of different fabrics within the network.

13. The non-transitory program storage device of claim 9, wherein the point of time along a circular outer ring is displayed with a moveable time frame indicator along the circular outer ring.

14. The non-transitory program storage device of claim 9, wherein the instructions further cause the one or more programmable control devices to set a time frame for the circular outer edge.

15. A system comprising:
at least one processor; and
storage coupled to the at least processor and storing computer-executable instructions for an application that cause the at least one processor to:
present a circular heat map graphical user interface (GUI) element that comprises:
a circular outer ring that represents a timeline and having markings that indicate portions of the timeline;
a plurality of wedge-like segments, wherein each of the wedge-like segments represents a different portion of a network;
a plurality of concentric rings, wherein each of the concentric rings represents a different network scope within a network, wherein the concentric rings divide each of the wedge-like segments into a plurality of sections, each section comprising the corresponding concentric ring network scope for that portion of the network; and
a plurality of network element indicators in the sections, each network element indicator representing a network element assigned to the particular section; and
display, on the presented circular heat map GUI element, the network element indicators appropriate for a point of time for the network, wherein the point of time corresponds to a portion of the circular outer ring, and wherein the network element indicator is a color that represents one or more network characteristics of the corresponding network element.

16. The system of claim 15, wherein the number of concentric rings within the circular heat map GUI element is determined from the number of different network scope classifications for the network.

17. The system of claim 15, wherein the network element indicators within each wedge-like segment correspond to nodes within a hierarchical network scope tree.

18. The system of claim 15, further comprising setting a time frame for the circular outer edge.

19. The system of claim 15, wherein the time frame for the circular outer ring is set to a day.

20. The system of claim 15, wherein the point of time along a circular outer ring is displayed with a moveable time frame indicator along the circular outer ring.
